(19) United States
(12) Patent Application Publication
(10) Pub. No.: US 2005/0289638 A1
(43) Pub. Date: Dec. 29, 2005

(54) Methods, systems, and products for providing broadcast video and IP data over a common, shared interface

(76) Inventor: David Steading, Marietta, GA (US)

Correspondence Address: SCOTT P. ZIMMERMAN, PLLC, PO BOX 3822, CARY, NC, 27519, US

(21) Appl. No.: 10/876,011

(22) Filed: Jun. 24, 2004

(51) Int. Cl. H04N 7/16; H04L 12/66

(52) U.S. Cl. 725/151

(57) ABSTRACT

Methods, systems, and products are disclosed for providing video and IP data over a common, shared coaxial interface. One method receives radio frequency signals via an input of a device. The input includes an interface to a coaxial cable. Packets of data are also received via the same input. Demodulation then recovers the packets of data and/or the radio frequency signals.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to electrical computers, interactive video distribution systems, multiple computer processing and, more particularly, to network-to-computer interfacing, set-top box receivers, and video distribution systems.

2. Description of the Related Art

Bandwidth is becoming a problem in the cable industry. As cable customers demand more and more services, the existing cable infrastructure cannot supply adequate bandwidth. If a video/cable customer wishes to only receive a traditional broadcast analog video signal (using the AM-VSB carrier), the existing cable infrastructure provides adequate bandwidth. If the customer wishes to receive broadcast digital services, those broadcast digital video signals can be modulated (using a QAM carrier) for delivery using the same cable infrastructure. If the customer wishes to receive switched digital broadcast signals, a multicast IP video technique converts MPEG video signals into IP packets. Those IP packets are then communicated in a multicast stream. Multiple customers, then, can receive that stream if they want to watch that particular channel. If a customer desires video-on-demand, however, that customer must receive a dedicated IP stream that provides service directly to the customer (uni-cast interactive EP video). If the customer desires interactive data services, the customer must receive a uni-cast EP service. If the cable customer wishes to receive all these services, the cable customer must receive greater bandwidth.

Advanced interactive video service is an example. Assume a cable customer wishes to view one channel and, at the same time, record another program on another channel. The cable customer, then, must receive two data streams. Perhaps the cable customer has “picture-in-a-picture” capabilities, so the cable customer must again receive two data streams. There are even situations where the cable customer may require more than two data streams. Each data stream, then, requires adequate bandwidth, and adequate bandwidth must consider peak traffic loading/congestion demands within the network infrastructure.

A set-top box, then, is used to receive and decode these cable services. The set-top box provides interactive video service by receiving either i) MPEG packets over a uni-cast IP connection or ii) MPEG packets over a narrow-cast RF QAM-modulated carrier. Most set-top box designs, in fact, receive interactive programming over the narrow-cast RF QAM-carrier. These set-top box designs receive digital broadcast programming over broadcast RF QAM carriers. A less common set-top box design receives both broadcast and interactive video service using high bandwidth multi-cast and uni-cast Internet Protocol connections. These set-top box designs have an RF connector that receives analog signals, or these IP-capable set-top box designs receive data packets over an Ethernet-type connector (e.g., an RJ45 connector).

If a cable service provider wishes to deliver both broadcast and interactive programming, the set-top box must have two inputs. The set-top box has an RF coaxial cable input for receiving the broadcast signals. The set-top box also has an Ethernet-type connector (e.g., the RJ45 connector) for receiving interactive video data. The set-top box, then, requires two physical connections.

These two physical connections, however, pose problems for many cable customers. Most homes and businesses are constructed, or retrofitted, with a coaxial cable connection. Few homes and businesses, however, do not have Category 5 (or better) wiring to support the Ethernet connection. This Ethernet-type connection, as mentioned above, is needed to deliver IP data. Many cable customers are deterred by the expense of installing Ethernet-compatible wiring. Many cable customers also detest additional drilled holes in their walls, ceiling and floors. Even cable service providers are deterred by the expense of providing this Ethernet-compatible wiring for/to their customers. There is, accordingly, a need in the art for delivering and for receiving the broadcast signals and the interactive video data over a shared mechanism, a need in the art for reducing the expense of advanced video services, and a need in the art for reducing the customer expense of receiving these advanced video services.

### BRIEF SUMMARY OF THE INVENTION

The aforementioned problems, and other problems, are reduced by this invention. This invention comprises methods and apparatuses that provide a common, shared delivery mechanism for both radio frequency signals and for Internet Protocol data. This invention describes how an electronic device can simultaneously receive RF broadcast signals and IP-based video data using a single input connection. Because this invention utilizes a common, shared input, this invention only requires a single coaxial cable connection. This invention does not require an additional communication connection, such as a telephone line or other twisted cabling (e.g., CAT3, 5, or 7 cabling). Users of this invention (e.g., residential and business customers) thus need not incur the expense of this additional wiring/cabling. Even though this invention simultaneously receives RF broadcast signals and IP-based video data over a single input connection, these inputs are still confined within the bandwidth available on an ITU-T G.983.3 Broadband PON. As this patent will describe, this invention allows the user to simultaneously receive/view/execute/store multiple programming. That is, the user can watch RF broadcast programming while storing/executing one or more IP data streams. The user may alternatively record the RF broadcast programming while executing/viewing one or more IP data streams. The simultaneously receipt of RF broadcast programming and one or more IP data streams allows multiple “picture within a picture” opportunities. This invention also allows the user to receive gaming and to process/distribute video/image data. Because this invention provides multiple outputs from a single coaxial cable input, this invention is also ideal for delivering programming and IP data to multiple, networked destinations.

This invention discloses methods, systems, and products for providing video and IP data over a common, shared coaxial interface. One of the embodiments receives radio frequency signals via an input of a device. The input includes an interface to a coaxial cable. Packets of data are also received via the same input. Demodulation then recovers the packets of data and/or the radio frequency signals.

Another of the embodiments describes a “set-top” box. As those of ordinary skill in the art understand, a set-top box (“STB”) is an electronic device that receives and decodes digital signals. A set-top box, for example, is commonly associated with television broadcasts. Another of the embodiments of this invention, then, receives radio frequency signals via an input of the set-top box. The input is an interface to the coaxial cable. Packets of data are also received via the same input of the set-top box, and demodulation recovers the packets of data and the radio frequency signals.

Yet another of the embodiments describes an electronic apparatus. This apparatus has an input, and the input includes an interface to a coaxial cable. A processor instructs a demodulator to recover i) packets of data received via the input and ii) radio frequency signals received via the same input.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIG. 1 is a simplified schematic illustrating an electronic apparatus according to the embodiments of this invention;

FIG. 2 is a schematic further illustrating an interface shown in FIG. 1;

FIG. 3 is a block diagram of the electronic apparatus shown in FIGS. 1 and 2, according to the embodiments of this invention;

FIG. 4 is a block diagram illustrating a set-top box receiver, according to the embodiments of this invention;

FIG. 5 is a more detailed block diagram illustrating the set-top box of FIG. 4, wherein the set-top box recovers multiple, interactive IP data streams, according to even more embodiments of this invention;

FIG. 6 is another block diagram illustrating the set-top box processing MPEG data, according to still more embodiments of this invention; and

FIG. 7 is a schematic illustrating a community antenna television network utilizing the teachings of this invention, according to yet more embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention provides a common, shared delivery mechanism for both radio frequency signals and for Internet Protocol data. This invention describes how an electronic device can simultaneously receive RF broadcast signals and IP-based video data using a single input connection. Because this invention utilizes a common, shared input, this invention only requires a single coaxial cable connection. This invention does not require an additional communication connection, such as a telephone line or other twisted cabling (e.g., CAT3, 5, or 7 cabling). Users of this invention (e.g., residential and business customers) thus need not incur the expense of this additional wiring/cabling. Even though this invention simultaneously receives RF broadcast signals and IP-based video data over a single input connection, these inputs are still confined within the bandwidth available on an ITU-T G.983.3 Broadband PON. As this patent will describe, this invention allows the user to simultaneously receive/view/execute/store multiple programming. That is, the user can watch RF broadcast programming while storing/executing one or more IP data streams. The user may alternatively record the RF broadcast programming while executing/viewing one or more IP data streams. The simultaneously receipt of RF broadcast programming and one or more IP data streams allows multiple “picture within a picture” opportunities. This invention also allows the user to receive gaming and to process/distribute video/image data. Because this invention provides multiple outputs from a single coaxial cable input, this invention is also ideal for delivering programming and IP data to multiple, networked destinations.

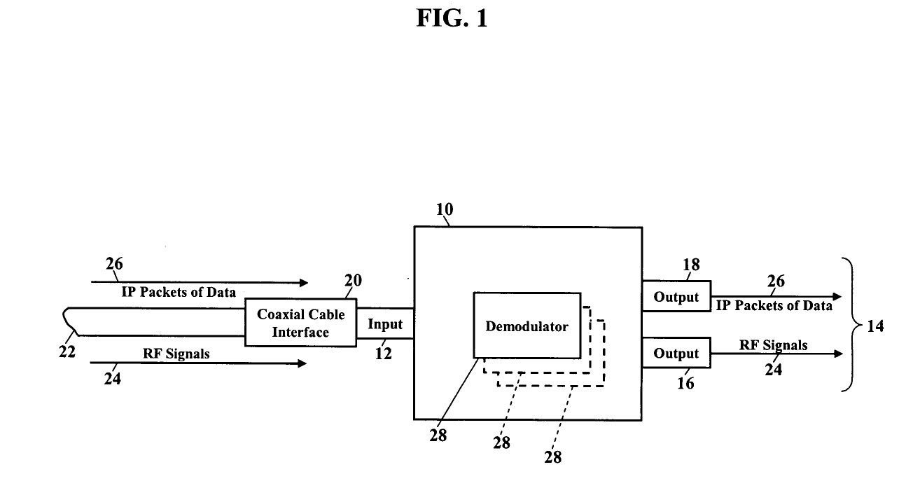

FIG. 1 is a simplified schematic illustrating an electronic apparatus 10 according to the embodiments of this invention. The electronic apparatus 10 can be any electrical device, such as an analog/digital recorder, television, CD/DVD player/recorder, audio equipment, receiver, tuner, and/or any other consumer electronic device. The apparatus 10 may also include any computer, peripheral device, camera, modem, storage device, telephone, personal digital assistant, and/or mobile phone. The apparatus 10 has an input terminal 12 and at least one output terminal 14. FIG. 1 shows the apparatus 10 having a first output terminal 16 and a second output terminal 18, although, as will be explained, a single output terminal is another embodiment. The input terminal 12 includes an interface 20 to a coaxial cable 22. The apparatus 10 receives radio frequency signals 24 via the input terminal 12. The apparatus 10 also receives packets of data 26 via the same input terminal 12. That is, both the radio frequency signals 24 and the packets of data 26 are communicated along the coaxial cable 22 to the apparatus 10. One or more demodulators 28 then recover the radio frequency signals 24 and/or the packets of data 26. The apparatus 10 then makes the radio frequency signals 24 available via the first output terminal 16. The apparatus 10 also makes the packets of data 26 available via the second output terminal 18. If, however, only one output is desired (whether the radio frequency signals 24 or the packets of data 26), then an additional output terminals may not be desired.

This invention, then, uses a shared, common terminal. As FIG. 1 shows, the coaxial cable 22 delivers both the radio frequency signals 24 and the packets of data 26 to the apparatus 10. An upstream modulator (not shown) modulates the Internet Protocol packets of data 26 with the RF signals 24. The coaxial cable 22 delivers the modulated signals to the apparatus 10, and the one or more demodulators 28 recover the radio frequency signals 24 and/or the Internet Protocol packets of data 26. Both the radio frequency signals 24 and the packets of data 26 are commonly communicated to the input terminal 12 via the coaxial cable 22.

The input terminal 12 includes the interface 20 to the coaxial cable 22. The interface 20 is any male or female coupling that allows the coaxial cable 22 to connect and/or communicate with the input terminal 12. The interface 20 could have a threaded or unthreaded portion. The interface 20 could be any modular plug, jack, crimp connector, twist-on connector, compression connector, snap connector, sealing connector, shielded connector, weather-resistant connector, heat-shrink connector, screw-type connector, threaded connector, and/or gold-plated connector. The interface 20 could be any banana connector, pin connector, soldered connector, spade connector, printed circuit board (“PCB”) connector, PCB-mounted connector, receptacle, and/or solderless connector. The interface 20, in short, can be any connector design that couples the coaxial cable 22 to the input terminal 12.

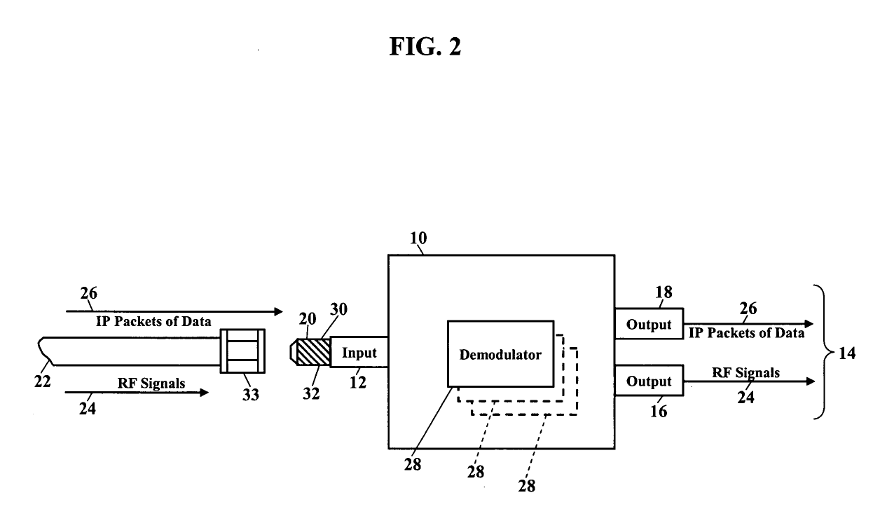

FIG. 2 is another schematic illustrating more of the embodiments of this invention. FIG. 2 is similar to FIG. 1, however, here the interface 20 is an “F” connector 30. As those of ordinary skill in the art recognize, the “F” connector 30 is commonly found on electronic equipment that couple to the coaxial cable 22. The “F” connector 30 is also widely used in the CATV and broadband industry. The “F” connector 30 has a threaded portion 32 onto which a mating coupler 33 of the coaxial cable 22 threads. The coaxial cable 22 delivers both the radio frequency signals 24 and the packets of data 26 to the apparatus 10. The one or more demodulators 28 then perform a demodulation process to recover the radio frequency signals 24 and/or the Internet Protocol packets of data 26. The coaxial cable 22 thus provides a common and shared delivery mechanism.

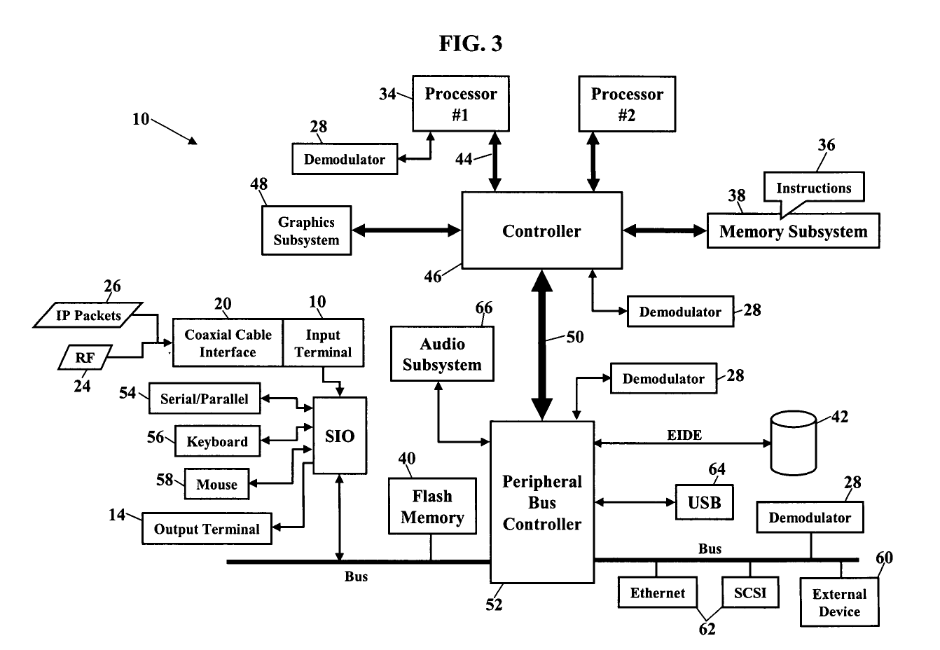

FIG. 3 is a block diagram of the apparatus 10 shown in FIGS. 1 and 2. The apparatus 10 can be any electrical device, such as an analog/digital recorder, television, CD/DVD player/recorder, audio equipment, receiver, tuner, and/or any other consumer electronic device. The apparatus 10 may also include any computer, peripheral device, camera, modem, storage device, telephone, personal digital assistant, and/or mobile phone. The apparatus 10 can be any electronic/electrical device that couples to the coaxial cable (shown as reference numeral 22 in FIGS. 1 and 2). The apparatus 10 includes the one or more demodulators 28 and one or more processors 34. One or more of the processors 34 execute instructions 36 stored in system memory device. When the processor 34 executes the instructions 36, the processor 36 instructs the one or more demodulators 28 to recover the packets of data 26 received via the input 10. The one or more processors 34 may also instruct the one or more demodulators 28 to recover the radio frequency signals 24 received via the same input 10. The instructions 36, for example, are shown residing in a memory subsystem 38. The instructions 36, however, could also reside in flash memory 40 or a peripheral storage device 42. The one or more processors 34 may also execute an operating system that controls the internal functions of the apparatus 10. A bus 44 may communicate signals, such as data signals, control signals, and address signals, between the processor 34 and a controller 46. The controller 46 provides a bridging function between the one or more processors 34, any graphics subsystem 48 (if desired), the memory subsystem 38, and, if needed, a peripheral bus 50. The peripheral bus 50 may be controlled by the controller 46, or the peripheral bus 50 may have a separate peripheral bus controller 52. The peripheral bus controller 52 serves as an input/output hub for various ports. These ports include the input terminal 10 and the at least one output terminal 14. The ports may also include a serial and/or parallel port 54, a keyboard port 56, and a mouse port 58. The ports may also include one or more external device ports 60, networking ports 62 (such as SCSI or Ethernet), and a USB port 64. The apparatus 10 may also include an audio subsystem 66. The apparatus 10 may also include a display device (such as LED, LCD, plasma, or any other) to present instructions, messages, tutorials, and other information to a user. The apparatus 10 may further include one or more encoders, one or more decoders, input/output control, logic, one or more receivers/transmitters/transceivers, one or more clock generators, one or more Ethernet/LAN interfaces, one or more analog-to-digital converters, one or more digital-to-analog converters, one or more “Firewire” interfaces, one or more modem interfaces, and/or one or more PCMCIA interfaces. Those of ordinary skill in the art understand that the program, processes, methods, and systems described in this patent are not limited to any particular architecture or hardware.

The processors 34 may be a digital signal processor (DSP) and/or a microprocessor. Advanced Micro Devices, Inc., for example, manufactures a full line of microprocessors (Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Texas Instruments offers a wide variety of digital signal processors (Texas Instruments, Incorporated, P.O. Box 660199, Dallas, Tex. 75266-0199, Phone: 972-995-2011, www.ti.com) as well as Motorola (Motorola, Incorporated, 1303 E. Algonquin Road, Schaumburg, Ill. 60196, Phone 847-576-5000, www.motorola.com). There are, in fact, many manufacturers and designers of digital signal processors, microprocessors, controllers, and other componentry that are described in this patent. Those of ordinary skill in the art understand that the concepts disclosed herein may be implemented using any design, architecture, and manufacture. Those of ordinary skill in the art, then understand that this invention is not limited to any particular manufacturer's component, nor architecture, nor manufacture.

The memory (shown as memory subsystem 88, flash memory 40, or peripheral storage device 42) may also contain an application program. The application program cooperates with the operating system and with a video display device to provide a Graphical User Interface (GUI). The graphical user interface provides a convenient visual and/or audible interface with a user of the apparatus 10.

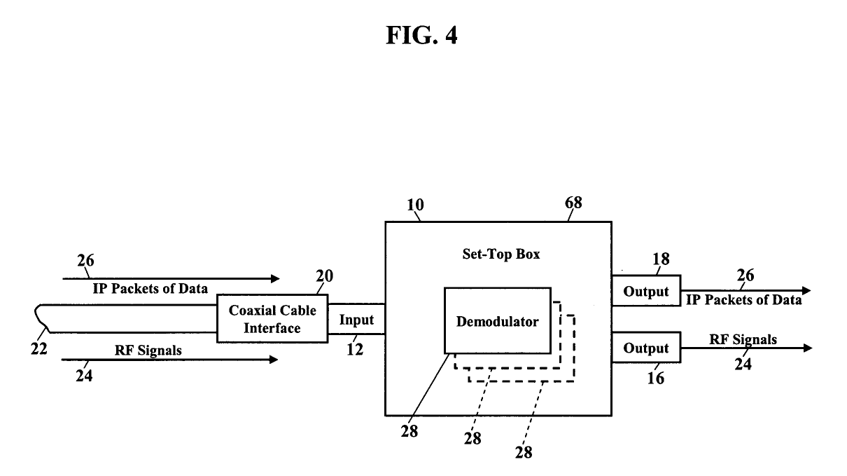

FIG. 4 is a block diagram illustrating another of the embodiments of this invention. FIG. 4 shows a set-top box receiver 68. As those of ordinary skill in the art understand, the set-top box (“STB”) 68 is an electronic device that receives and decodes digital signals. The set-top box 68, for example, is commonly associated with television broadcasts. The set-top box 68, then, is another electronic apparatus 10 that includes the teachings of this invention. The set-top box 68 receives the radio frequency signals 24 via the input terminal 12. The input 12 includes the interface 20 to the coaxial cable 22. The Internet Protocol packets of data 26 are also received via the same input 12 of the set-top box 68. The one or more demodulators 28 then recover the radio frequency signals 24 and/or the packets of data 26. The set-top box 68 then makes the radio frequency signals 24 available via the first output terminal 16. The set-top box 68 also makes the packets of data 26 available via the second output terminal 18.

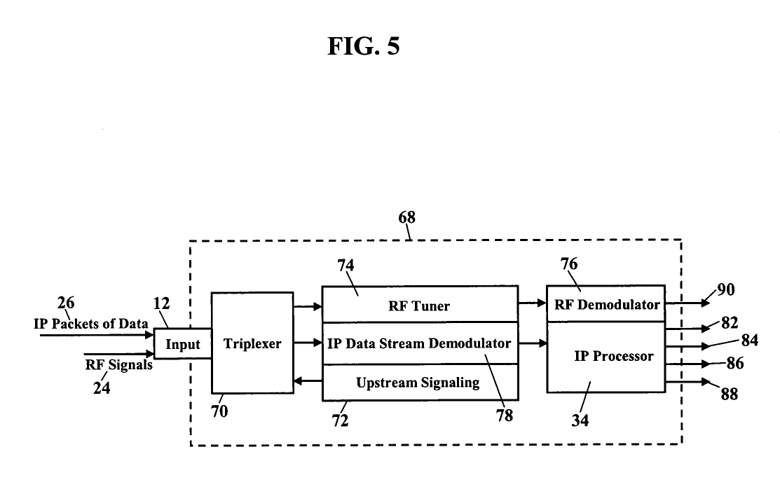

FIG. 5 is a more detailed block diagram illustrating the set-top box 68. FIG. 5 illustrates that this invention may be applied to recover multiple, interactive IP data streams. These multiple IP data streams would permit a user to view programming while simultaneously recording one or more other programs. That is, the set-top box 68 could receive multiple data streams of packets that are modulated with the RF broadcast signals.

FIG. 5 illustrates the multiple data streams. The set-top box 68 receives the radio frequency signals 24 via the input terminal 12. The Internet Protocol packets of data 26 are also received via the same input 12 of the set-top box 68. A triplexer 70 separates the radio frequency signals 24 and the packets of data 26. The triplexer 70 also creates a third channel for upstream signaling 72. An RF tuner 74 sends the radio frequency signals 24 to an RF demodulator 76. An IP data stream demodulator 78 demodulates the packets of data 26. The packets of data 26 are then communicated to one or more of the processors 34. The processor 34 processes the contents of the packets of data 26. The processor 34 may also group/arrange the packets of data 26 into data streams 82, 84, 86, and 88. These multiple IP data streams 82, 84, 86, and 88 could then be utilized in any fashion. A user, for example, could view an output 90 from the RF demodulator while simultaneously recording one or more of the data streams 82, 84, 86, and 88. One or more of the data streams 82, 84, 86, and 88 could be provided as a “picture within a picture.” Any of the data streams 82, 84, 86, and 88 could be further distributed to other electronic devices via a communications network. However the individual data streams 82, 84, 86, and 88 are used, this invention allows the coaxial cable (shown as reference numeral 22 in FIGS. 1 and 2) to provide a common and shared delivery mechanism.

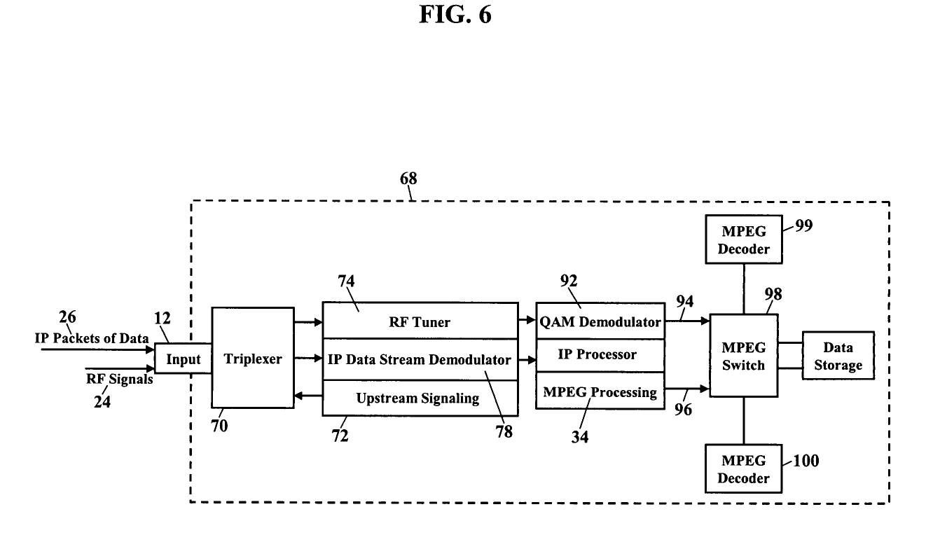

FIG. 6 is another block diagram illustrating the set-top box 68. FIG. 6 is similar to FIG. 5 and shows the teaching of this patent applied to MPEG data. As those of ordinary skill in the art understand, the Moving Pictures Expert Group (MPEG) is working group of the International Standards Organization (ISO). The acronym “MPEG” refers to a family of digital video compression standards and file formats developed by the group. Here the broadcast video RF tuner 74 sends the radio frequency signals 24 to a Quadrature Amplitude Modulation (QAM) demodulator 92. The QAM demodulator 92 outputs MPEG packets of data 94. The IP data stream demodulator 78 demodulates the packets of data 26. The processor 34 processes the contents of the packets of data 26 into more MPEG packets of data 96. The MPEG packets of data 94 and 96 are routed to an MPEG switch 98. The MPEG switch 98 then routes the MPEG packets of data 94 and 96 to respective MPEG decoders 99 and 100. The output of either MPEG decoder 99 and 100 is then available for delivery to other devices, for viewing, and/or for recording. As FIG. 6 shows, either MPEG packets of data 94 and/or 96 could be routed to memory for storage (such as the memory subsystem 88, flash memory 40, or peripheral storage device 42 shown in FIG. 3). One or more of the IP data stream demodulators 78 could demodulate multiple IP data streams, thus allowing the one or more processors 34 to process multiple streams of MPEG packets of data. Each stream of MPEG packets of data could be routed to one or more of the MPEG switches 98, and therefore to one or more of the MPEG decoders. The set-top box 68, then, can produce multiple output streams of IP data for viewing, for storage, and for distribution.

This invention provides a common and shared delivery mechanism for RF signals and for IP data streams. This invention demodulates a coaxial cable input to recover one or more IP data streams. This demodulation may utilize any method, technique, or process of demodulation that can be applied to signals communicated via coaxial cable. Just a few of the demodulation techniques would include any of the Home Cable Network Alliance (HCNA) standards, any of the I.E.E.E. 802 family of standards applied over coaxial cable, any Data Over Cable Service Interface Specification (DOCSIS), AM/FM demodulation, any Technology, Media, and Telecom (TMT) specification, and even techniques developed by commercial suppliers (such as Entropic Communications of San Diego, Calif.).

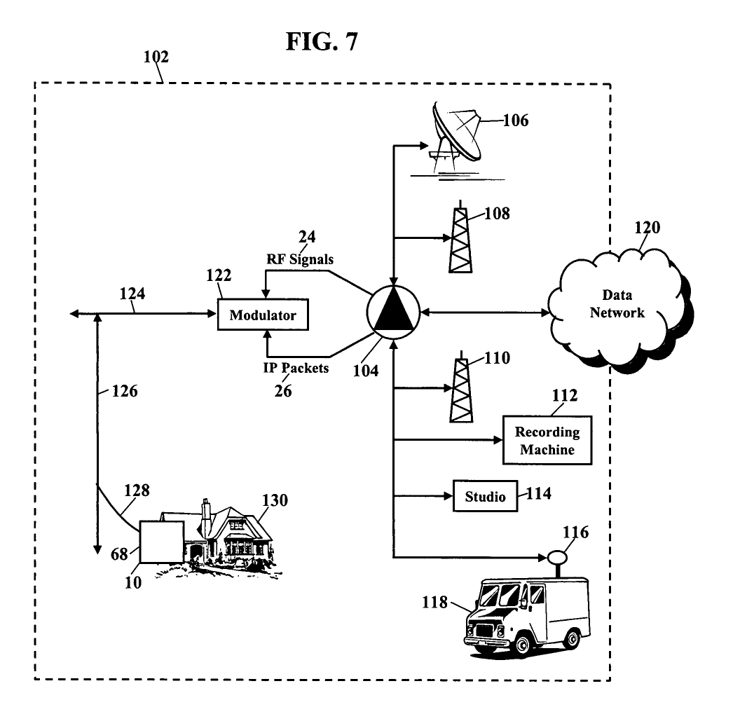

FIG. 7 is a schematic illustrating a community antenna television network 102. The term “community antenna television network,” as used herein, is a generic term describing any cable network. “Community antenna television network,” or CATV, is generally used to describe cable television networks and cable television. See, e.g., SHLOMO OVADIA, BROADBAND CABLE TV ACCESS NETWORKS 2n.1 (2001). Because “community antenna television network” is generically used to describe any cable television network, the term “community antenna television network” encompasses coaxial cable networks, fiber optic networks, hybrid fiber and coax networks, and wireless links within these networks (e.g., radio-frequency (RF) and microwave).

As FIG. 7 shows, a cable headend 104 is an origination point for content in the community antenna television network 102. The headend 104 receives content from various sources and distributes, or delivers, the content along the community antenna television network 102. The headend 104, for example, may receive content from a satellite system 106, from a distant broadcaster 108, from a local broadcaster 110, from recording machines 112 that playback taped content, and from a studio 114 that originates content. The headend 104 may also receive content via an electromagnetic link 116 (e.g., RF and microwave). A mobile studio 118, for example, often supplies coverage of sporting events and other live events via this electromagnetic link 116. The headend 104 may also send and receive the Internet Protocol packets of data 26 via a distributed computing data network 120, such as the Internet (sometimes alternatively known as the “World Wide Web”), an intranet, a local-area network (LAN), and/or a wide-area network (WAN). A modulator 122 modulates the radio frequency signals 24 and the IP packets of data 26 onto a system of one or more trunk cables 124. The modulator may use any modulation technique to simultaneously communicate the radio frequency signals 24 and the IP packets of data 26. The system of one or more trunk cables 124 distributes the modulated signals to a system of one or more distribution cables 126. A drop cable 128 delivers the modulated signals from the distribution cable 126 to the electronic apparatus 10 at a subscriber's premises 130. Because the community antenna television network 102 is well understood, this patent only presents a simplified discussion of cable networks. If the reader desires a more detailed discussion of cable networks, the reader is directed to CICORA ET AL., MODERN CABLE TELEVISION TECHNOLOGY 9-13 (1999) and to SHLOMO OVADIA, BROADBAND CABLE TV ACCESS NETWORKS 1-10 (2001), each of which is incorporated herein by reference.

The modulator 122 performs a modulation of the radio frequency signals 24 and the IP packets of data 26. The modulator 122 receives the radio frequency signals 24 and the IP packets of data 26. The modulator 122 modulates these signals 24 and 26 and provides the modulated signals for communication along a coaxial cable. The coaxial cable provides a common and shared delivery mechanism for the RF signals 24 and for the IP data streams 26. The modulator 122 may utilize any method, technique, or process of modulation that can be applied to signals communicated via coaxial cable. Just a few of the modulation techniques would include any of the Home Cable Network Alliance (HCNA) standards, any of the I.E.E.E. 802 family of standards applied over coaxial cable, any Data Over Cable Service Interface Specification (DOCSIS), AM/FM demodulation, any Technology, Media, and Telecom (TMT) specification, and even techniques developed by commercial suppliers (such as Entropic Communications of San Diego, Calif.).

The modulator 122 can be physically located anywhere within the community antenna television network 102. Although the modulator 122 is shown receiving signals from the headend 104, the modulator 122 could alternatively or additionally be located at any location within the system of trunk cables 124, the distribution cables 126, along the drop cable 128, and/or within the subscriber's premises 130. The modulator 122 could alternatively or additionally be located upstream or downstream from the headend 104. The modulator 122, for example, could alternatively or additionally be located at any location within the satellite system 106, the distant broadcaster 108, the local broadcaster 110, the recording machines 112, the studio 114, the electromagnetic link 116, the mobile studio 118, and/or the distributed computing data network 120.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A method, comprising the steps of:
receiving radio frequency signals via an input of a device, the input interfacing with a coaxial cable;
receiving packets of data via the same input of the device, and
demodulating to recover the packets of data.

2. A method according to claim 1, further comprising the step of demodulating to recover the radio frequency signals.

3. A method, comprising the steps of:
receiving radio frequency signals via an input of a set-top box, the input interfacing with a coaxial cable;
receiving packets of data via the same input of the set-top box,
demodulating to recover the packets of data and the radio frequency signals.

4. A method according to claim 3, further comprising demodulating to recover multiple streams of packets of data, each stream of packets of data representing separate video programming.

5. An apparatus, comprising:
a set-top box decoding digital signals;
an input to the set-top box having an interface to a coaxial cable; and
a processor instructing a demodulator to recover i) packets of data received via the input and ii) radio frequency signals received via the same input,
wherein the set-top box receives both the packets of data and the radio frequency signals via the coaxial cable.

6. An apparatus according to claim 5, further comprising memory for storing instructions.

7. An apparatus according to claim 5, further comprising a mass-storage device.

8. An apparatus according to claim 5, further comprising a decoder.

9. An apparatus according to claim 5, further comprising a clock.

10. An apparatus according to claim 5, further comprising a USB interface.

11. An apparatus according to claim 5, further comprising a display device.

12. An apparatus according to claim 5, further comprising an output.
